(19) United States
(12) Patent Application Publication
(10) Pub. No.: US 2022/0109784 A1
(43) Pub. Date: Apr. 7, 2022

(54) MUTLIPLE APERATURE AND SINGLE CAMERA DEVICE

(71) Applicant: Lenovo (Singapore) Pte. Ltd., Singapore (SG)

(72) Inventors: Russell Speight VanBlon, Raleigh, NC (US); Mark Patrick Delaney, Raleigh, NC (US); Arnold S. Weksler, Raleigh, NC (US); Nathan J. Peterson, Oxford, NC (US); John Carl Mese, Cary, NC (US)

(21) Appl. No.: 17/062,156

(22) Filed: Oct. 2, 2020

(51) Int. Cl. H04N 5/225; H04N 5/232; H04N 5/247

(52) U.S. Cl. CPC H04N 5/2254; H04N 5/247; H04N 5/23216

(57) ABSTRACT

One embodiment provides an information handling device, comprising: a single camera system; a first aperture for image capturing and being located on a front side of the information handling device; a second aperture for image capturing and being located on a back side of the information handling device; and a reflective mechanism, wherein the reflective mechanism reflects light from one of the first aperture and the second aperture into the single camera system. Other aspects are described and claimed.

### BACKGROUND

Information handling devices, particularly smart phone and other smart personal devices, have been utilizing a rear facing camera and a front facing camera for some time. The presence and use of two cameras on a single device has become customary in user smart devices at this point. As smart phones and devices have transitioned to being everyday use items, and image capturing has been vastly promoted during the current social media boom, it is easy to say that image capturing occurs more today than ever before.

### BRIEF SUMMARY

In summary, one aspect provides an information handling device, comprising: a single camera system; a first aperture for image capturing and being located on a front side of the information handling device; a second aperture for image capturing and being located on a back side of the information handling device; and a reflective mechanism, wherein the reflective mechanism reflects light from one of the first aperture and the second aperture into the single camera system.

Another aspect provides a method, comprising: detecting, at an information handling device comprising a single camera system, a user input for capturing an image; identifying a camera orientation for capturing the image, wherein the camera orientation comprises one of: a front camera orientation and a rear camera orientation, wherein in the front camera orientation light enters through a first aperture on a front side of the information handling device and wherein in the rear camera orientation light enters through a second aperture on a back side of the information handling device; and capturing, using the single camera system and based upon the selected camera orientation, the image, wherein the capturing comprises directing light utilizing at least one reflective mechanism from an aperture corresponding to the camera orientation to the single camera system.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of selecting an aperture and directing light through the selected aperture.

FIG. 4 illustrates an example device utilizing a simple mirror or prism setup in V-shape.

FIG. 5 illustrates an example device utilizing a multiple mirror setup.

FIG. 6 illustrates an example device utilizing multiple pieces of glass to direct light accepted from an aperture to the device sensor.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Conventional methods utilizing a front facing camera and rear facing camera commonly use two separate camera systems included within a single information handling device. Each camera system includes a lens and other camera hardware with no sharing of hardware between the camera systems. A rear facing camera was initially implemented into an information handling device alone. This addition of a rear facing camera permitted a user to take pictures in a traditional manner, i.e., the user holding the camera lens away from the user, and capturing an image that is in front of the camera lens. This traditional picture taking technique allowed a display of the information handling device to act as an “eye-hole” as is present on traditional cameras or act as the display on the back of a digital camera. The addition of the front facing camera then permitted the user to take a picture of the user viewing the display simultaneously. Acting in a mirror-like technique, the front facing camera allowed easy capturing of a user utilizing a device. This implementation of the front facing camera is credited with creating the “selfie.”

As one can imagine, the implementation of a camera into a device comes with a cost increase. Being that camera systems are not free, the addition of a camera will increase the price of an information handling device. Thus, with the addition of the front facing camera another cost-adding component was added to a system. In society today, we do not think about the additional cost that the second camera system adds to the device because we are accustomed to having both of them at this point. However, there was a time, not all that long ago, that you could get a device with one or two camera systems and see a clear difference in price.

Additionally, as technology advances the quality of the cameras produced have become better. Resolution of images, styles of pictures to be taken, photo assistant technology, and the like, have since gotten better and will continue to be added to updated camera models. This includes the camera systems present in a personal device having multiple camera systems (e.g., tablet, smart watch, smart phone, etc.). Since the rear facing camera was implemented first, there have been massive strides in updating the quality of image captured from the rear camera. Additionally, the rear facing camera can be placed in locations that allow for larger camera system components, which allow for better components. For example, in the early 2000's, a flip camera phone may have contained a camera system that would capture an image with a 4 megapixel resolution. At the time, this was a top tier camera resolution to have in a user device. The rear camera present in a personal device today (year 2020) will capture an image with a resolution upwards of 12 megapixels. This is large increase in the resolution of the image captured, and in a few years the 12 megapixel resolution may become obsolete.

As for the front facing camera, since this type of camera has not been used in devices for the same amount of time as the rear camera, the resolutions for a front facing camera are regularly less. Additionally, because of the display of the device, the camera system components for the front facing camera must be smaller and, therefore, cannot be the latest technology. Thus, the use of two separate camera systems (one for the front facing camera and one for the rear facing camera) causes a notable increase in the price of an information handling device. Additionally, due to space and size constraints the quality of images captured with the front facing camera are inferior to those captured with the rear facing camera.

Accordingly, an embodiment provides a system and method for utilizing a single camera system present within an information handling device to capture images from both a front point-of-view and a rear point-of-view, in relation to the device orientation. In an embodiment, a system may contain at least two apertures, one permitting capturing a front facing image and the other permitting capturing a rear facing image. In order to use a single camera system, the information handling device may contain a reflective mechanism that directs light from either of the two apertures to the camera system to capture an image in the orientation selected by the user.

To prevent the system from attempting to capture two images simultaneously by having both apertures accepting light and thus trying to capture a picture through both opened apertures, the system may adjust the reflective properties of or restrict the light from entering the aperture from the orientation a user does not desire to use. For example, if a user elects to take a selfie using the front facing orientation, the system may reduce reflective properties of surfaces associated with the rear facing orientation to restrict the light from entering the system from the rear camera point-of-view. In an embodiment, the resolution of an image captured from either orientation may be the same. In other words, since a single camera system is used for both image capturing orientations, the quality of an image captured in either the front facing orientation or the rear facing orientation is the same. The implementation of such a single camera system into a user device may increase the overall quality of all images captured while simultaneously decreasing the amount of components needed within a system to capture an image; thus, decreasing the price of an information handling device while still allowing image capture from multiple locations of the information handling device.

The illustrated example embodiments will be best understood by reference to the figures. The following description is intended only by way of example, and simply illustrates certain example embodiments.

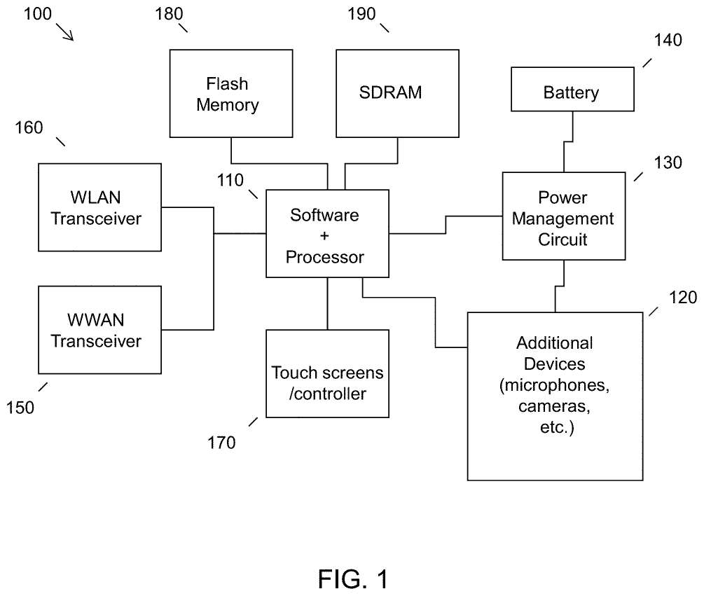

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

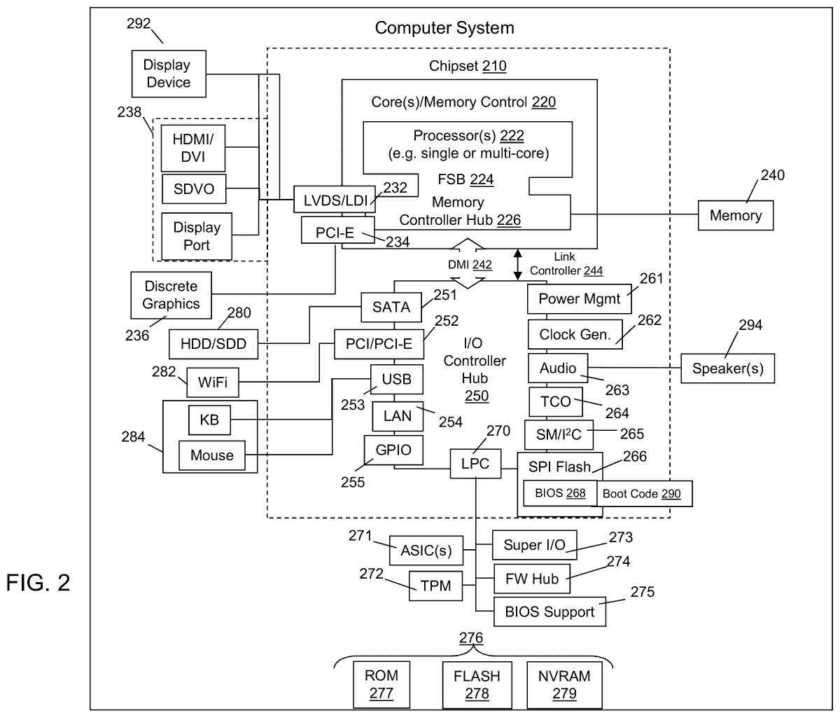

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RANI that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling circuitry, as for example outlined in FIG. 1 or FIG. 2, may be used in devices that are capable of capturing images from multiple locations on the device. For example, the circuitry outlined in FIG. 1 may be implemented in a smart phone or tablet embodiment, whereas the circuitry outlined in FIG. 2 may be implemented in a laptop.

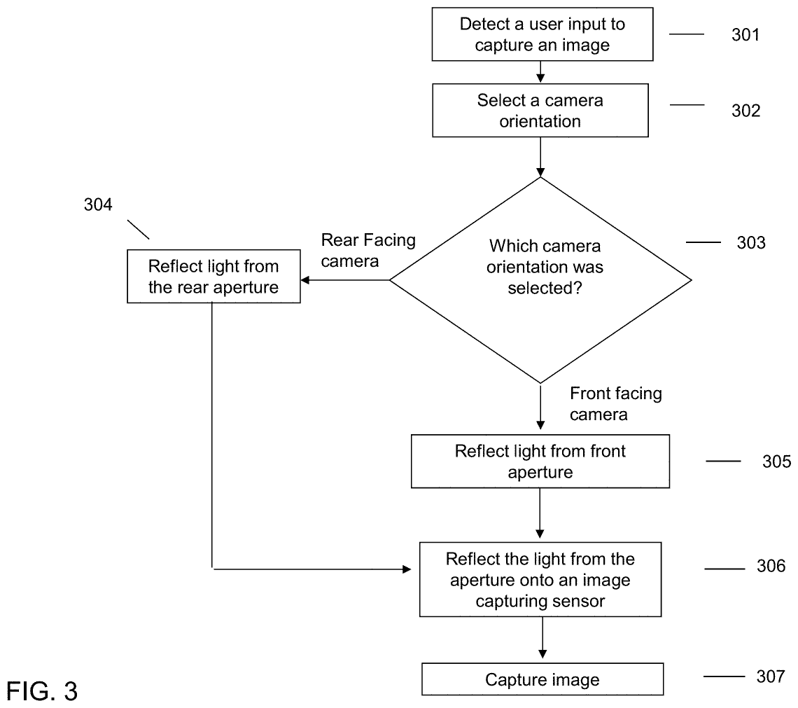

Referring now to FIG. 3, an embodiment provides a method for capturing an image based upon a user selected camera orientation by use of a reflective mechanism within the information handling device which allows light from one aperture and may restrict light from another aperture. At 301, in an embodiment, the system may detect a user input at the information handling device indicating that a user desires to capture an image. In an embodiment, the user input may include selecting an application associated with image capturing present on a user's personal information handling device. In an embodiment, the user input may include providing an audible or gesture-based input to an information handling device indicating the desire to capture an image. For ease of readability, a personal information handling device will be the exemplary use case of the described system. However, it should be understood that the described system can be applied to any device having more than one image capture aperture.

After providing an indication to capture an image, a user may select a camera orientation to be used to capture the image at 302. In an embodiment, the selection may include the user electing to use the front camera orientation which includes the use of a front facing aperture. Throughout this disclosure, front facing, front camera orientation, first aperture, and the like, will refer to the aperture present on the display portion of the information handling device that a user is viewing. For example, the front camera orientation may provide a mirror-like image capturing technique. In other words, the front facing aperture is the one commonly associated with a “selfie”. This is not intended to limit the scope of this invention, but rather to allow a reader to understand the orientations.

In an embodiment, the selection may include the user electing to use a rear camera orientation. Throughout this disclosure, rear facing, rear camera orientation, second or another aperture, and the like, will refer to the aperture present on the backside of an information handling device, opposite a user capturing an image and opposite the display of the information handling device. In other words, the rear facing aperture is the one commonly associated with a “world-view”. Again, this is not intended to limit the scope of this invention, but rather to allow the reader to understand the orientations.

At 303 the system may determine which camera orientation was selected by the user. Since the system utilizes a single camera system that includes a single set of camera hardware and components, but still allows image capturing from multiple aperture locations, the system must identify which orientation is selected so that light can be appropriately directed. Thus, the system determines whether the rear orientation or the front orientation has been selected. Based upon the orientation, the system determines which aperture should be utilized for capturing the image.

If the rear orientation is selected, the system identifies the rear facing aperture as the active aperture. Thus, the system utilizes a reflective mechanism to direct or reflect light from the rear facing aperture at 304. If the front orientation is selected, the system identifies the front aperture as the active aperture. Thus, the system utilizes a reflective mechanism to direct or reflect light from the front facing aperture at 305. In addition to reflecting or directing light from the correct aperture, the system may also restrict light from entering the device from the other aperture. This prevents the system from attempting to capture an image from both apertures simultaneously and ensures the intended orientation is utilized to capture the image. Regardless of the orientation selected, the reflective mechanism directs or reflects light from the selected aperture onto an image capture sensor or the single camera system at 306. In other words, regardless of the selected aperture, the light is directed or reflected to the same location, the single camera system of the information handling device. This then results in the image being captured at 307.

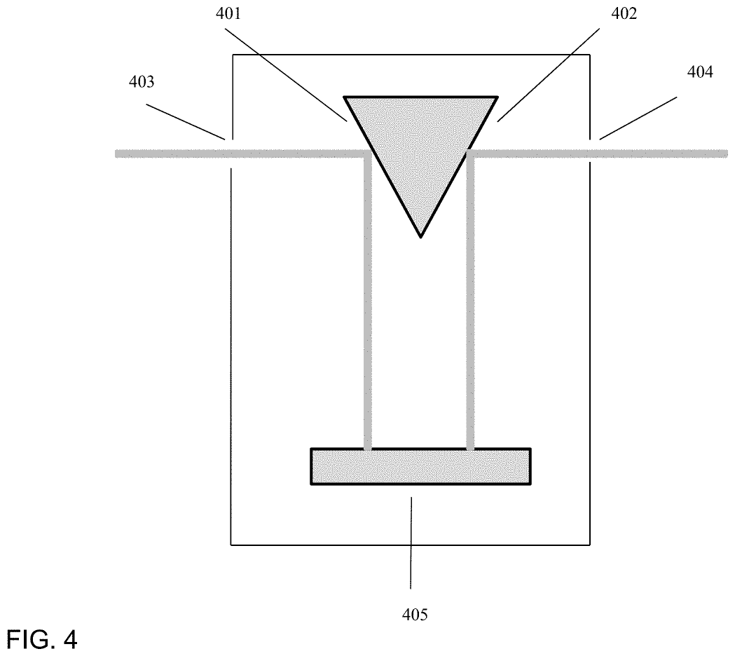

To direct or reflect light from the proper aperture, the system utilizes a reflective mechanism. The reflective mechanism may be one of a variety of mechanisms, from a simple mirror to a more complicated electrochromic smart glass. FIG. 4 illustrates an example of a simple mirror or prism set up. The mirrors or prisms 401 and 402 are configured in a V-shape where light from the selected aperture 403 or 404 is directed at a 90° angle into the single image capture sensor or single camera system 405. Depending on the location of the image capture sensor or single camera system, the orientation of the mirrors or prisms may be adjusted to reflect or direct the light at a different angle in order to reach the image capture sensor or single camera system. Additionally, or alternatively, a different shaped mirror may be used. For example, instead of a flat mirror, a concave or convex mirror may be utilized. In other words, while illustrative, FIG. 4 is not meant to be specifically limiting to a particular angle of the mirrors or prism or a specific type of mirror (concave, convex, flat, etc.).

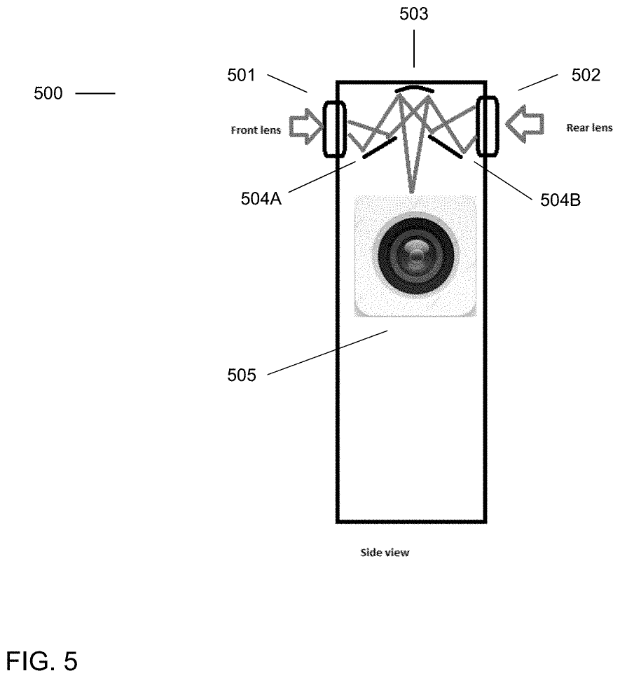

The reflective mechanism may also be a more complicated series of mirrors. FIG. 5 illustrates an example of this more complicated mirror or prism set up 500 within a device. In an embodiment, the front aperture 501 and the rear aperture 502 may be selected. In this example even though the single camera system 505 is in a stationary location, a simpler mirror system may be unable to be utilized. Thus, the system includes two mirrors or prisms, one for each aperture 504A and 504B. These mirrors or prisms 504A and 504B, reflect or direct the light onto another mirror or prism 503, which is a concave mirror in this example, that reflects or directs the light onto the single camera system or image capture sensor 505.

Additional mirrors may also be utilized if the front facing and rear facing apertures are offset from each other. In some embodiments, the front facing and rear facing apertures may be in line with each other. In other words, the front facing and rear facing apertures are in the same location relative to the front and back of the device. This may allow for a simpler mirror set up. On the other hand, if the front facing and rear facing apertures are offset from each other, additional mirrors may be required in order to get the light from the apertures to the single camera system. This offset orientation is found in a large portion of the devices since the front facing aperture is generally located higher on the device than the rear facing aperture due to the display. As an example, the front facing aperture may be a few millimeters from the top of the front of the device, whereas the rear facing aperture may be closer to the center of the device on the back. Thus, an additional mirror or set of mirrors may be required to account for the offset configuration of the apertures.

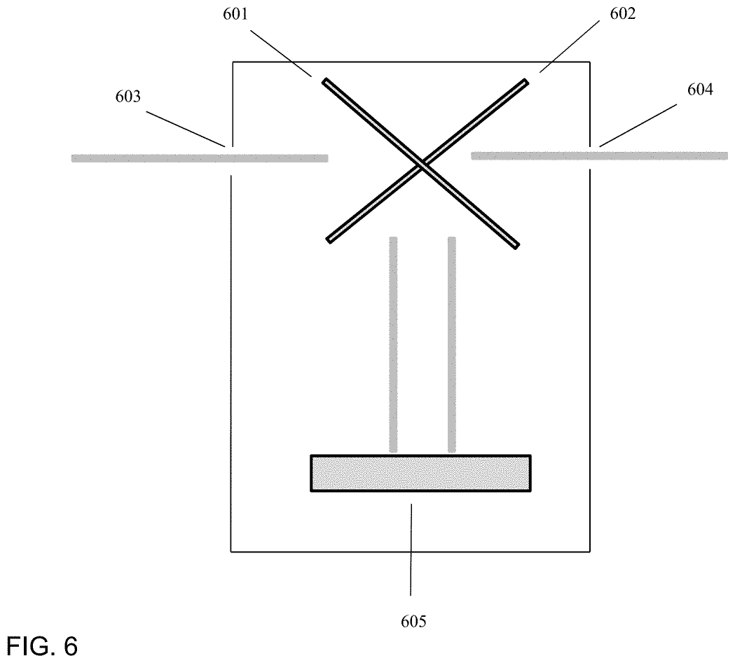

FIG. 6 illustrates a more complicated system that requires additional components. In this example, two pieces of glass 601 and 602 are configured in an X shape. One piece of glass is a clear piece of glass and the other piece of glass is a reflective piece of glass. While two pieces of glass are discussed, this could also be configured with three, four, or more pieces of glass. For example, each leg of the X may be a separate piece of glass resulting in four total pieces of glass. Depending on the aperture selected 603 and 604, the system allows light through the clear piece of glass and onto the reflective piece of glass to reflect or direct the light onto the single camera system 605. In order to prevent cross light, the system may include a motorized lens (not shown) that uncovers the correct set of glass so that the light can be directed from the correct aperture.

Another reflective mechanism that may be utilized in any of FIG. 4, 5, or 6, is an electrochromic smart glass, glass tint, or LCD color. Instead of using a mirror, prism, or glass, the system could utilize any of the above. An electrochromic smart glass is able to be electrically changed from having a level of reflection and being transparent. Other reflective and/or clear devices can be used, for example, reflective plastic optics, glass, or the like. In other words, any reflective substance or device may be used in the location where a reflective surface is needed and any clear substance or device may be used in the location where a clear surface is needed.

The various embodiments described herein thus represent a technical improvement to conventional methods for utilizing a system that contains multiple camera orientations. Rather than needing multiple camera systems, the system and method uses a single camera setup that may capture images for the all the camera orientations present on a device. The use of a single camera setup assists in a constant resolution and quality of images captured using the device. Additionally, the lack of needing an individual camera setup for each camera orientation of the device will decrease the components needed to operate a device; thus, decreasing the overall price of the device. Such a method may more intelligently approach capturing an image using a device containing multiple apertures in a highly efficient manner.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An information handling device, comprising:
a single camera system;
a first aperture for image capturing and being located on a front side of the information handling device;
a second aperture for image capturing and being located on a back side of the information handling device; and
a reflective mechanism, wherein the reflective mechanism reflects light from one of the first aperture and the second aperture into the single camera system.

2. The information handling device of claim 1, wherein a selected one of the first aperture and the second aperture is based upon an image capturing orientation selected by a user of the information handling device.

3. The information handling device of claim 1, wherein the reflective mechanism comprises at least one mirror.

4. The information handling device of claim 3, wherein the at least one mirror reflects the light 90° from the one of the first aperture and the second aperture to the single camera system.

5. The information handling device of claim 3, wherein the at least one mirror comprises a series of mirrors that reflect light into the single camera system.

6. The information handling device of claim 3, wherein the at least one mirror comprises at least one concave mirror.

7. The information handling device of claim 1, wherein the reflective mechanism comprises at least two pieces of glass, wherein one of the at least two pieces of glass comprises a clear piece of glass and wherein another of the at least two pieces of glass comprises a reflective piece of glass.

8. The information handling device of claim 7, comprising a motorized lens cover that uncovers one side of the at least two pieces of glass to reflect the light from the one of the first aperture and the second aperture.

9. The information handling device of claim 1, wherein the reflective mechanism comprises at least one of: electrochromic smart glass, reflective plastic optics, and glass.

10. The information handling device of claim 1, wherein the first aperture is in line with the second aperture.

11. The information handling device of claim 1, wherein the first aperture is offset from the second aperture.

12. The information handling device of claim 11, comprising at least one mirror to reflect light to account for the offset.

13. The method, comprising:
detecting, at an information handling device comprising a single camera system, a user input for capturing an image;
identifying a camera orientation for capturing the image, wherein the camera orientation comprises one of: a front camera orientation and a rear camera orientation, wherein in the front camera orientation light enters through a first aperture on a front side of the information handling device and wherein in the rear camera orientation light enters through a second aperture on a back side of the information handling device; and
capturing, using the single camera system and based upon the selected camera orientation, the image, wherein the capturing comprises directing light utilizing at least one reflective mechanism from an aperture corresponding to the camera orientation to the single camera system.

14. The method of claim 13, wherein the reflective mechanism comprises at least one mirror.

15. The method of claim 14, wherein the at least one mirror reflects the light 90° from the one of the first aperture and the second aperture to the single camera system.

16. The method of claim 14, wherein the at least one mirror comprises a series of mirrors that reflect light into the single camera system.

17. The method of claim 14, wherein the at least one mirror comprises at least one mirror concave mirror.

18. The method of claim 13, wherein the reflective mechanism comprises at least two pieces of glass, wherein one of the at least two pieces of glass comprises a clear piece of glass and wherein another of the at least two pieces of glass comprises a reflective piece of glass.

19. The method of claim 18, comprising a motorized lens cover that uncovers one side of the at least two pieces of glass to reflect the light from the one of the first aperture and the second aperture.

20. The method of claim 13, wherein the reflective mechanism comprises at least one of: electrochromic smart glass, reflective plastic optics, and glass.
